(19) United States
(12) Patent Application Publication
(10) Pub. No.: US 2026/0027012 A1
(43) Pub. Date: Jan. 29, 2026

(54) Medicine Feeding Apparatus

(71) Applicant: Takazono Corporation, Kadoma-shi (JP)

(72) Inventors: Naoya Sugimoto, Kadoma-shi (JP); Keita Kira, Kadoma-shi (JP)

(21) Appl. No.: 18/874,109

(22) PCT Filed: Aug. 28, 2023
(86) PCT No.: PCT/JP2023/030972

§ 371 Date: Oct. 10, 2025

(30) Foreign Application Priority Data
Sep. 28, 2022 (JP) 2022-154817

(51) Int. Cl. A61J 3/00

(52) U.S. Cl. CPC A61J 3/00; A61J 2200/00

(57) ABSTRACT

Provided is a medicine feeding apparatus including a receiving member including a plurality of receiving parts in which medicine can be received, and an apparatus main body that feeds the medicine received in the plurality of receiving parts to a target device. The plurality of receiving parts are open upward and configured to allow an operator to manually place the medicine from above thereinto. The receiving member includes a plurality of position indicators that indicate which of the plurality of receiving parts the medicine should be placed thereinto. The receiving member is configured to be attachable to and detachable from the apparatus main body.

### CROSS-REFERENCE TO RELATED APPLICATION

This application claims priority to Japanese Patent Application No. 2022-154817, the disclosure of which is incorporated herein by reference in its entirety.

### FIELD

The present invention relates to a medicine feeding apparatus for feeding medicine.

### BACKGROUND

A manual medicine feeding apparatus as disclosed in Patent Literature 1 is known as a conventional medicine feeding apparatus. The manual medicine feeding apparatus includes a manual medicine feeding part partitioned into a grid shape to have a plurality of medicine receiving parts into which an operator manually places (manually distributes) medicine; and a position indicator formed of an LED disposed close to each one of the plurality of medicine receiving parts.

With the above-described manual medicine feeding apparatus, the operator can perform manual distribution operation by placing medicine into those medicine receiving parts at positions corresponding to the position indicators at which the LEDs light, thereby enabling the medicine to be efficiently received in the medicine receiving parts.

### CITATION LIST

### Patent Literature

Patent Literature 1: International Publication No. 2011/125650

### SUMMARY

### Technical Problem

There has been a demand for improved usability in the manual medicine feeding apparatus described in Patent Literature 1. In view of this, an object of the present invention is to provide a medicine feeding apparatus that is easy to use.

### Solution to Problem

The medicine feeding apparatus of the present invention is a medicine feeding apparatus including a receiving member including a plurality of receiving parts in which medicine can be received, and an apparatus main body that feeds the medicine received in the plurality of receiving parts to a target device, in which the plurality of receiving parts are open upward and configured to allow an operator to manually place the medicine from above thereinto; the receiving member includes a plurality of position indicators that indicate which of the plurality of receiving parts the medicine should be placed thereinto; and the receiving member is configured to be attachable to and detachable from the apparatus main body.

### BRIEF DESCRIPTION OF DRAWINGS

FIG. 1 is a perspective view of a medicine packaging apparatus including a medicine feeding apparatus according to an embodiment of the present invention.

FIG. 2 is a plan view showing a receiving member and an apparatus main body of the medicine feeding apparatus.

FIG. 3 is a plan view showing an apparatus main body of the medicine feeding apparatus.

FIG. 4 is a cross sectional view taken along IV-IV shown in FIG. 2.

FIG. 5 is a plan view of a receiving member with a portion thereof removed to show a bottom part of the receiving member.

FIG. 6 is a rear view of the apparatus main body showing an opening/closing drive part disposed in the apparatus main body, with parts unnecessary for explanation removed.

FIG. 7A is a diagram showing a first stage in the former half of the drive of the opening/closing drive part.

FIG. 7B is a diagram showing a second stage in the former half of the drive of the opening/closing drive part.

FIG. 7C is a diagram showing a third stage in the former half of the drive of the opening/closing drive part.

FIG. 7D is a diagram showing a fourth stage in the former half of the drive of the opening/closing drive part.

FIG. 8A is a diagram showing a first stage in the latter half of the drive of the opening/closing drive.

FIG. 8B is a diagram showing a second stage in the latter half of the drive of the opening/closing drive part.

FIG. 8C is a diagram showing a third stage in the latter half of the drive of the opening/closing drive part.

FIG. 8D is a diagram showing a fourth stage in the latter half of the drive of the opening/closing drive part.

FIG. 9A is a diagram showing a state in which the medicine feeding apparatus is advanced out of a housing.

FIG. 9B shows a state in which the medicine feeding apparatus is retracted into the housing.

FIG. 10A is a diagram showing a state in which the receiving member and a mounting frame part of the medicine feeding apparatus are advanced out of the housing.

FIG. 10B is a diagram showing an intermediate stage in which the receiving member and the mounting frame part of the medicine feeding apparatus are retracted relative to the housing.

FIG. 10C is a diagram showing a state in which the receiving member and the mounting frame part of the medicine feeding apparatus are retracted relative to the housing.

FIG. 11 is a block diagram showing a configuration of a destaticizer of the medicine feeding apparatus.

FIG. 12 is a flow chart showing control relating to the operation of the destaticizer.

### DESCRIPTION OF EMBODIMENTS

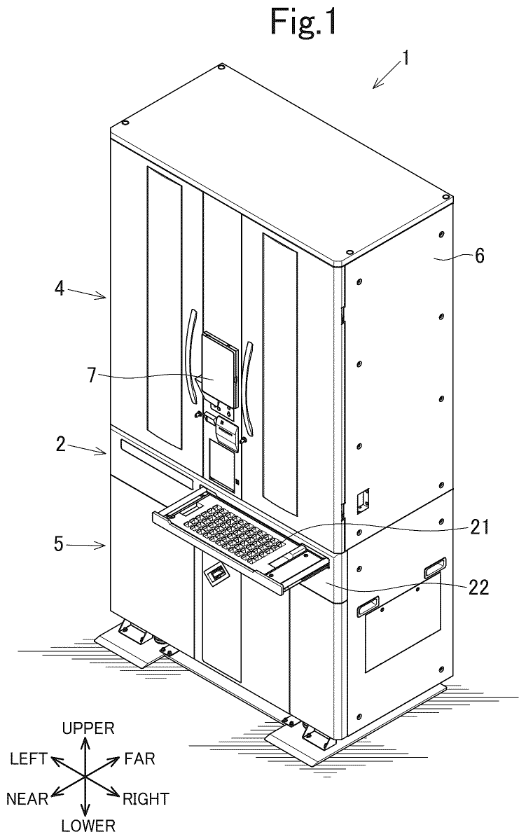

A medicine feeding apparatus 2 according to an embodiment of the present invention will be described with reference to FIG. 1 to FIG. 12. A description on vertical, right-left, and depth directions will be given based on the directions of the apparatus when installed. Specifically, the depth direction refers to a direction orthogonal to a front surface of a housing 6, a front side will be referred to as a near side, and the rear side will be referred to as a far side. The left and right direction will be described based on the left and right direction when viewed from the front side.

The medicine feeding apparatus 2 of this embodiment is configured as a part of a medicine packaging apparatus 1 that packages medicine. First, a description will be given on the medicine packaging apparatus 1 with reference to FIG. 1.

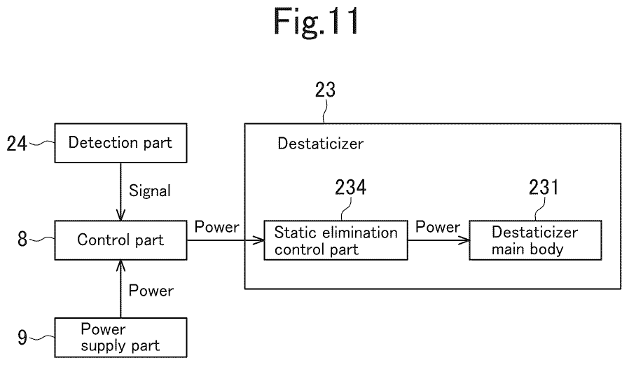

As shown in FIG. 1, the medicine packaging apparatus 1 is an apparatus configured to package medicine per dose in a package such as packaging paper. Specifically, the medicine packaging apparatus 1 includes: an automatic feeding apparatus 4 including a plurality of cassettes (not shown) in which the medicine is stored, and capable of feeding the medicine stored in the cassettes; the medicine feeding apparatus 2 configured to feed manually distributed medicine; a packaging part 5 that packages the medicine fed from the automatic feeding apparatus 4 and the medicine feeding apparatus 2 in the package; and a housing 6 having a box shape for housing the automatic feeding apparatus 4, the medicine feeding apparatus 2, and the packaging part 5 therein. The medicine packaging apparatus 1 further includes an input part 7 capable of inputting prescription information relating to information on the medicine to be packaged, and a control part 8 (see FIG. 11) for controlling the entire medicine packaging apparatus 1. In this embodiment, the medicine stored in the cassette and the medicine fed into the medicine feeding apparatus 2 are tablets or capsules. However, depending on the configuration of the medicine packaging apparatus 1, powder medicine may also be housed in the cassette, and in such a case, powder medicine and tablets are packaged together in a package or separately in different packages.

The automatic feeding apparatus 4 has a plurality of types of medicine stored therein. Specifically, in the automatic feeding apparatus 4, the plurality of types of medicine are stored in the separate cassettes. Further, the automatic feeding apparatus 4 is configured to feed the stored medicine to the packaging part 5 in response to an instruction from the controller part 8. The automatic feeding apparatus 4 can also include a plurality of cassettes storing a single type of medicine to be fed in a large amount.

The packaging part 5 is a portion for packaging doses of the medicine fed from the automatic feeding apparatus 4 and the medicine feeding apparatus 2 in the separate packages. The packaging part 5 is a portion disposed below the automatic feeding apparatus 4 and the medicine feeding apparatus 2. In this embodiment, the medicine fed from the automatic feeding apparatus 4 and the medicine feeding apparatus 2 moves by gravity through a medicine feeding passage (not shown) within the housing 6, and is fed to the packaging part 5.

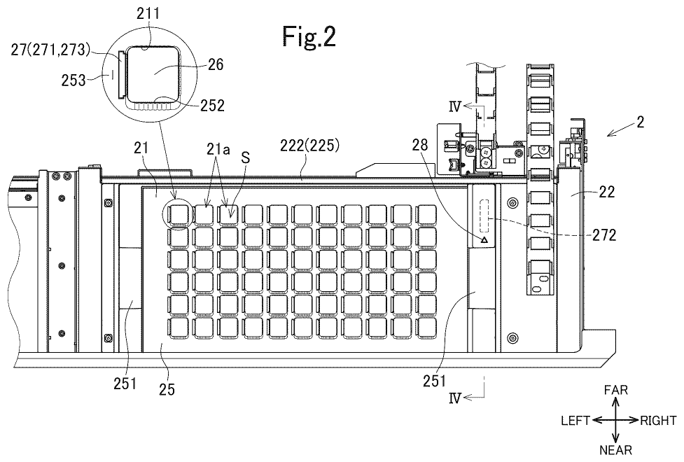

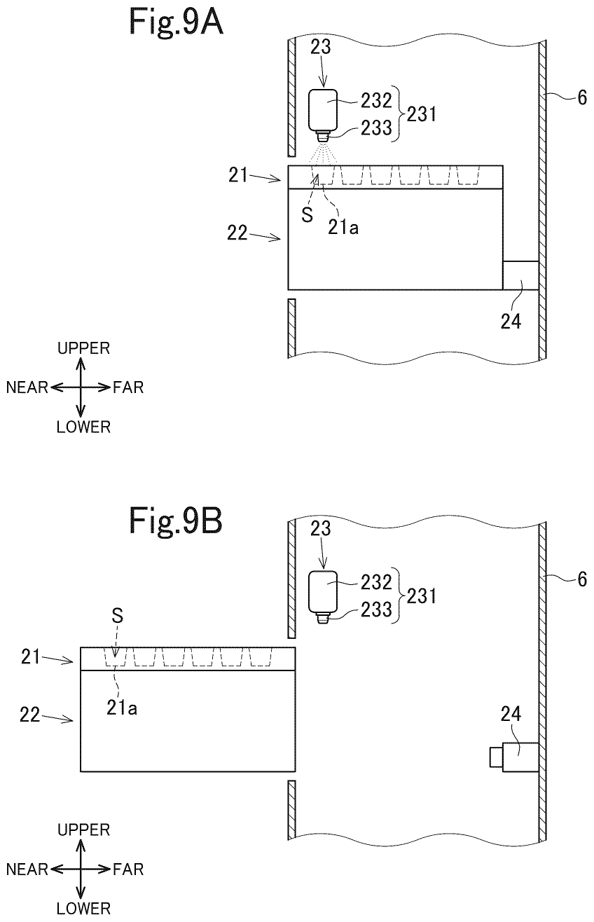

As shown in FIG. 1 and FIG. 2, the medicine feeding apparatus 2 is configured to allow the medicine to be placed thereinto by manual distribution, and the placed medicine to be fed to a target device (packaging part 5 of the medicine packaging apparatus 1). Specifically, the medicine feeding apparatus 2 includes: a receiving member 21 including a plurality of receiving parts 21a in which the manually distributed medicine can be received; an apparatus main body 22 that feeds the medicine received in the receiving parts 21a to a target device (packaging part 5); a destaticizer 23 (see FIG. 9A and FIG. 9B) that eliminates static electricity from the medicine received in the receiving parts 21a, a detection part 24 (see FIG. 9A and FIG. 9B), and the housing 6. The housing 6 in the medicine feeding apparatus 2 of this embodiment is a part of the housing 6 of the medicine packaging apparatus 1. The medicine feeding apparatus 2 includes an input part 7 that can input prescription information relating to information on the medicine to be received therein, and a controller part 8 that controls the medicine feeding apparatus 2. The input part 6 and the controller part 8 of this embodiment are configured integrally with the input part 7 and the controller part 8 of the medicine packaging apparatus 1. In this embodiment, the receiving member 21 is configured to be detachable from the apparatus main body 22, so that the medicine can be manually distributed into the receiving member 21 at a location away from the medicine feeding apparatus 2 after the receiving member 21 is detached from the apparatus main body 22. It can be configured such that a plurality of receiving members 21 are prepared for one medicine feeding apparatus 2, and medicine is manually distributed into the receiving members 21 in advance while they are detached from the apparatus main body 22. In such a case, manual distribution can be carried out efficiently.

The receiving member 21 includes the plurality of receiving parts 21a each defining a receiving area S as a recess in which the medicine can be received, and is a plate-shaped body having a smaller thickness than a horizontal dimension (i.e., length in the left-right direction) and a depth dimension (i.e., length in the depth direction). Specifically, the receiving member 21 includes a receiving member main body 25 which has a plate shape and has a plurality of holes penetrating in the thickness direction thereof, the inner wall of each hole defining a side of the corresponding receiving part 21a, a bottom part 26 which has a plate shape and is disposed below the receiving member main body 25 to define the lower side of the receiving part 21a, and a position indicator 27 which is disposed in the receiving member main body 25. The bottom part 26 and the receiving member main body 25 form each of the receiving parts 21a. The receiving part 21a opens upward and is a box-shaped part into which the operator can manually place the medicine from above. The receiving parts 21a are arranged in multiple rows in the horizontal direction. Specifically, disposed are a plurality of rows of the receiving parts 21a (11 rows in this embodiment), each row including a plurality of receiving parts 12 (six in this embodiment) arranged in the depth direction. The receiving member 21 includes a finger hook 251. The finger hook 251 in this embodiment is a cutout portion formed in the upper surface of the receiving member main body 25.

Each of the receiving parts 21a is a box-shaped part opening upward and has a side surface that defines the side of the receiving area S capable of receiving medicine. The receiving part 21a is composed of the bottom part 26 and the receiving member main body 25, and specifically, is a portion in which the bottom part 26 serves as a bottom surface, and a side wall 211 (in this embodiment, an inner wall of the hole of the receiving member main body 25) extending upward from the bottom part 26 serves as a side surface. The side wall 211 is configured as a partition wall that partitions between the receiving areas S of the adjacent receiving parts 21a. Further, the side wall 211 in this embodiment is configured in a tapered shape such that the lower end side of the receiving area S is narrow and the upper end side is wide, and an unevenness 252 is formed on the inner surface. In the inner surface of the side wall 17 of this embodiment, a plurality of grooves extending along the vertical direction are formed as the unevenness 252. A position indicator 27, which will be described later, is disposed inside the side wall 211.

An upper end surface of the receiving part 12 surrounding the receiving area S is provided with an identification mark 253 for identifying the receiving part 21a. The identification mark 253 is a mark located at a position adjacent to the receiving area S. The identification mark 253 of this embodiment is a numerical figure shown on a left side of the receiving area S of each receiving parts 21a. Further, the numerical figure shown as the identification marks 253 represents the order in which the medicine placed in the corresponding receiving part 21a is packaged. That is, medicine placed in the receiving area S of the receiving part 21a with the identification mark 253 of “1” on the left side is packaged in the first package. The identification mark 253 of this embodiment is printed on the upper end surface of the receiving part 21a. Further, the identification mark 253 is shown to be identifiable when viewed from the front side of the receiving member 11. The numerical figure as the identification mark 253 of this embodiment is shown to have a lower portion directed to the front side and an upper portion directed to the back side. The identification mark 253 can be placed on the upper surface of a light transmission part 273, which will be described later.

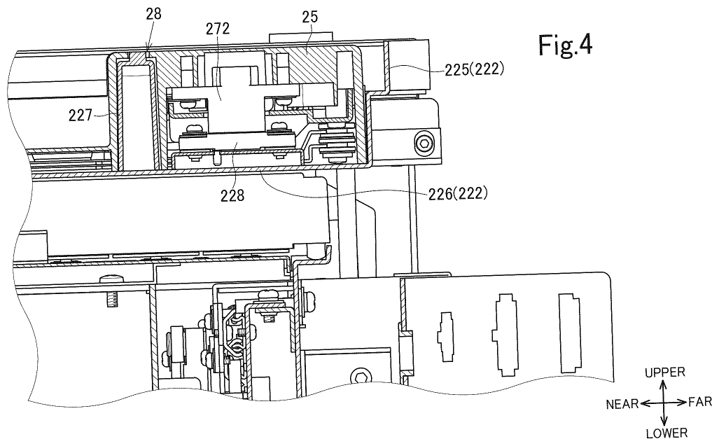

As shown in FIG. 2 and FIG. 4, the receiving member main body 25 is a plate shaped body having a plurality of holes penetrating therethrough in the thickness direction. The receiving member main body 25 also includes a positioning recess 28 for positioning the receiving member main body 25 relative to a mounting frame part 222, which will be described later. The positioning recess 28 is a recess having a shape corresponding to a positioning protrusion 227 disposed on the mounting frame part 222. The positioning recess 28 of this embodiment is a hole formed so as to penetrate the receiving member main body 25 in the thickness direction. The positioning recess 28 is disposed at a position offset to either the left or right in the left-right direction of the receiving member main body 25 and offset to either the front or rear in the depth direction, and in this embodiment is disposed at a position close to the back side of the right end.

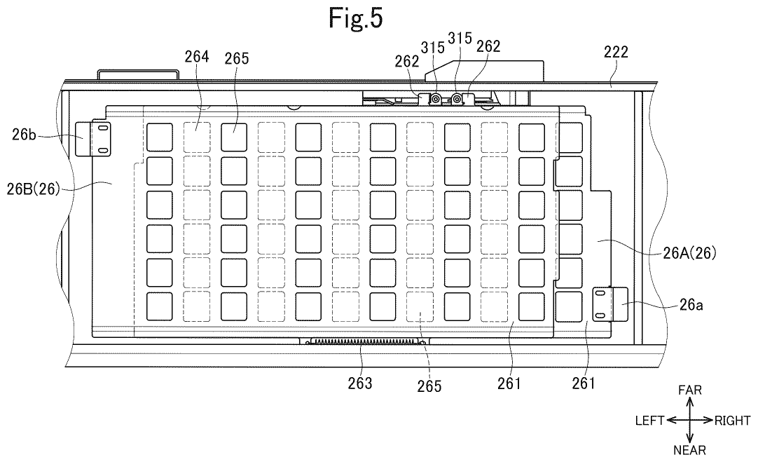

As shown in FIG. 5, the bottom part 26 is a plate shaped body that forms the bottom surface of the receiving part 21a, and is configured so that the bottom of the receiving part 21a can be opened and closed. Specifically, the bottom part 26 is formed by combining a pair of bottom plate parts (a first bottom plate part 26A and a second bottom plate part 26B) each having a plurality of opening portions 265 with holes penetrating in the thickness direction. The first bottom plate part 26A and the second bottom plate part 26B each include a bottom plate main body 261 that opens and closes the bottom of the receiving parts 21a, and an opening/closing engagement part 262 that is connected to the bottom plate main body 261 and engages with the opening/closing drive part 3 of the apparatus main body 22 described later in a state where the receiving member 21 is attached to the mounting frame part 222. The opening/closing engagement part 262 is a protrusion disposed at an end portion on the far side of the bottom part 26 and extending toward the far side. The bottom part 26 includes a first connection part 26a and a second connection part 26b, in which the first connection part 26a is arranged to abut against the first bottom plate part 26A and the second connection part 26b is arranged to abut against the second bottom plate part 26B, at a fixed position (a position closing the lower side of the receiving part 21a). Both the first connection part 26a and the second connection part 26b are conductive, and each are located at a position at which they are electrically connected (in contact) with a grounding part 229 described later in a state where the receiving member 21 is mounted in the mounting recess 22a.

The bottom plate main body 261 includes closing portions 264 that close the bottom of the receiving part 21a, and opening portions 265 that open the bottom of the receiving part 21a. Each opening portion 265 is a portion in which a hole penetrating in the thickness direction is formed. The closing portions 264 and the opening portions 265 are arranged alternately in the left-right direction. In this embodiment, the first bottom plate part 26A and the second bottom plate part 26B are arranged so as to be displaced in the left-right direction to overlap each other, and specifically, each of the closing portions 264 and each of the opening portions 265 are arranged so as to overlap each other in the vertical direction. Further, the closing portions 264 and the opening portions 265 are disposed at positions corresponding to the lower side of the receiving parts 21a. With this configuration, the closing portions 264 of either the first bottom plate part 26A or the second bottom plate part 26B can close the bottom of the receiving part 21a. The first bottom plate part 26A and the second bottom plate part 26B move relative to each other in the left-right direction so that the opening portions 265 overlap each other in the vertical direction, thereby opening the bottom of the receiving part 21a. In this embodiment, the first bottom plate part 26A and the second bottom plate part 26B are biased by a spring 263 so that the closing portions 264 of either the first bottom plate part 26A or the second bottom plate part 26B are positioned at a fixed position (position shown in FIG. 2) at which they can close the bottoms of the receiving parts 21a. That is, the fixed positions of the first bottom plate part 26A and the second bottom plate part 26B are positions at which they close the bottoms of all the receiving parts 21a. The bottom plate main body 261 is entirely made of a conductive material, specifically, a metal. In this way, the first bottom plate part 26A and the second bottom plate part 26B each are biased by the spring 263 to be arranged at a fixed position, so that when no external force is applied, the bias can maintain the first bottom plate part 26A in abutment with the first connection part 26a and the second bottom plate part 26B in abutment with the second connection part 26b.

As shown in FIG. 2, the position indicator 27 is disposed in a space inside the side wall 211. The position indicator 27 is a part configured to be able to project light onto the inner wall surface of the receiving part 21a. The position indicator 27 of this embodiment has a light source (not shown) and includes a light projecting part 271 that projects light onto the inner wall surface of the receiving part 21a, a base plate (not shown) that is disposed inside the side wall 211, and a first connector 272 that is electrically connected to the base plate. The light source in this embodiment is an LED. In this embodiment, the position indicator 27 is disposed on the left side of each receiving part 21a. Further, the position indicator 27 of this embodiment is provided in the upper half of the receiving part 21a in the vertical direction.

The light projector 271 is a part for illuminating the inner wall surface. Specifically, the light projecting part 271 is provided inside the side wall 211 and includes a light source that emits light to illuminate the inner wall surface, and a light transmission part 273 that transmits the light emitted by the light source. The light transmission part 273 is a plate shaped body configured to scatter the light emitted from the light source, and in this embodiment, is a milky white plate shaped body. The light transmission part 273 is provided to form a part of the side wall 211. Specifically, a cutout is formed in the side wall 211 to provide communication between the inside and the outside of the side wall 211, and the light transmission part 273 is a plate shaped body fitted into the cutout formed in the side wall 211. The light projecting part 271 forms a part of the upper end surface surrounding the receiving area S, and is configured so that the light emitted from the light source can be recognized from above the receiving part 21a.

As shown in FIG. 4, the first connector 272 is a connector that is provided so as to protrude to the lower side of the receiving member main body 25, and is fixed to the receiving member main body 25. The first connector 272 is connectable to a second connector 228 provided in the apparatus main body 22. The first connector 272 of this embodiment is provided with a plurality of terminals, specifically, a power feeding terminal for power feeding, a communication terminal for information communication, and a ground terminal for electrical grounding.

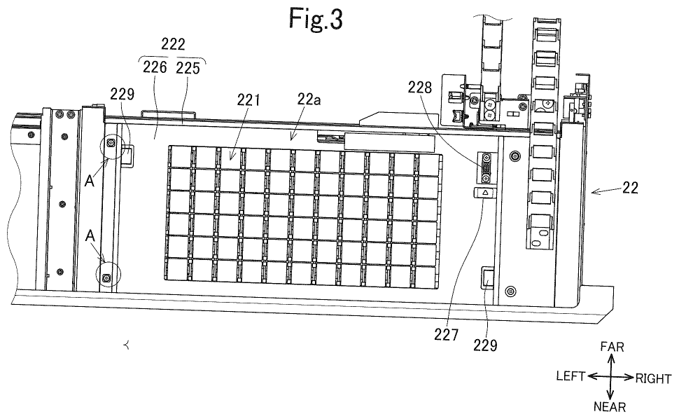

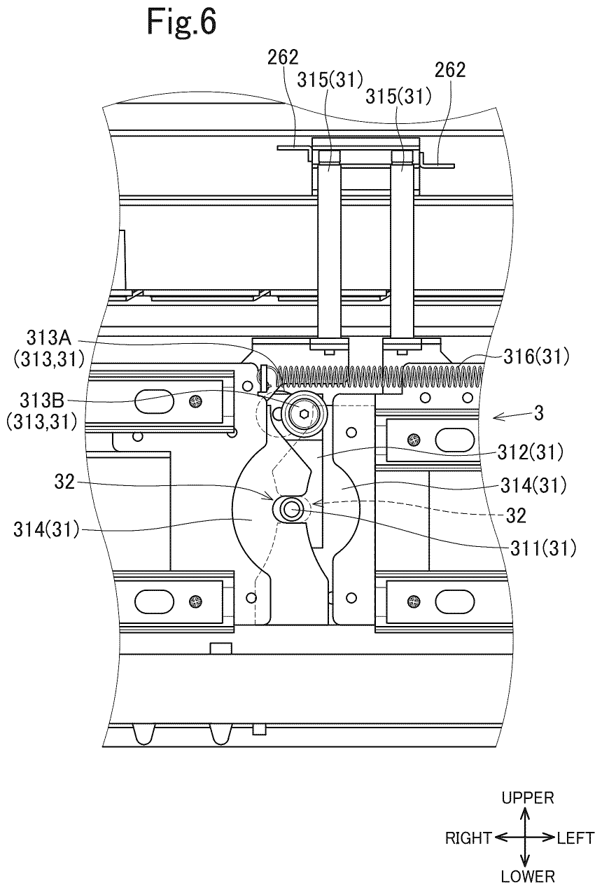

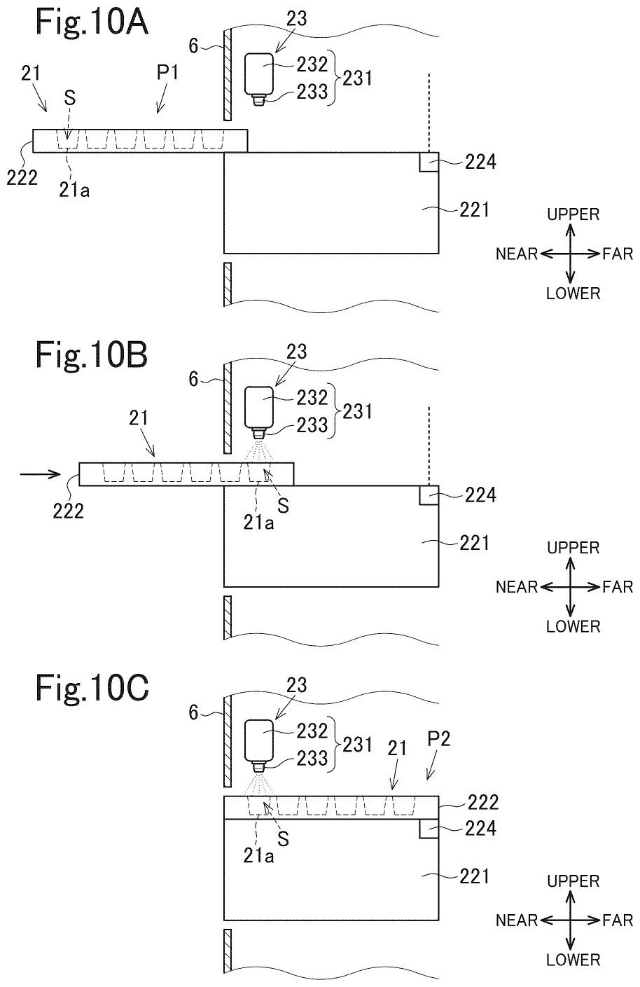

As shown in FIG. 3, FIG. 9A and FIG. 9B, the apparatus main body 22 temporarily receives the medicine received in the receiving member 21, and feeds the received medicine to the packaging part 5 at a certain timing. Specifically, the apparatus main body 22 includes: an apparatus base part 221 that receives the medicine received in the receiving member 21 and feeds the same to the packaging part 5; a mounting frame part 222 that is disposed on the upper part of the apparatus main body 22 and to which the receiving member 21 can be mounted; an opening/closing drive part 3 (see FIG. 6) that engages with the bottom part 26 of the receiving member 21 mounted on the mounting frame part 222 (specifically, opening/closing engagement part 262) to open and close the bottom part 26; and an extension/retraction drive part (not shown) that moves the mounting frame part 222 horizontally in the depth direction. The apparatus main body 22 is configured to be entirely movable in and out of the housing 6, and in the normal state, as shown in FIG. 1 and FIG. 9A, the apparatus main body 22 is housed in the housing 6, an d as shown in FIG. 9B, the apparatus main body 22 is configured to be able to be pulled out toward the front from the housing 6 when cleaning or the like. Even when the apparatus main body 22 is housed in the housing 6 as shown in FIG. 10A to FIG. 10C, only the mounting frame part 222 can be moved in and out of the housing 6 by the extension/retraction drive part. The extension/retraction drive part of this embodiment is equipped with a housing sensor 224 capable of detecting that the mounting frame part 222 is located at a housing position P2, which is the position at which the mounting frame part 222 is housed in the housing 6. The housing sensor 224 of this embodiment is a magnetic sensor disposed on the upper surface of the apparatus base part 221, and detects a magnet disposed in the mounting frame part 222. The housing sensor 224 is configured to detect the fact that the mounting frame part 222 has been housed in the housing 6.

As shown in FIG. 3, the mounting frame part 222 is a frame on which the receiving member 21 can be mounted. Specifically, the mounting frame part 222 includes: a frame part 225 that surrounds a horizontal outer edge portion of the receiving member 21 to be mounted; a housing bottom part 226 that is connected to a lower portion of the frame part 225 and is opposed to the lower surface of the receiving member 21 to be mounted; a positioning protrusion 227 that is fitted to the receiving member 21 to be mounted (specifically, the positioning recess 28); a second connector 228; and a grounding part 229. The frame part 225 and the housing bottom part 226 are recessed downward and form a mounting recess 22a large enough to house the receiving member 21. A hole is formed in the housing bottom part 226, which penetrates therethrough in the vertical direction at a position corresponding to the bottom of the receiving part 21a of the attached receiving member 21, so that medicine falling downward from the receiving part 21a can pass through the housing bottom part 226 and fall onto the apparatus base part 221.

The mounting frame part 222 of this embodiment is configured to be movable between the housing position P2 at which the mounting frame part 222 is housed in the housing space inside the housing 6 with the receiving member 21 attached to the mounting frame part 222, and a protruding position PI at which the mounting frame part 222 protrudes to the outside from the housing 6 (see FIG. 10A to FIG. 10C). Specifically, the mounting frame part 222 is driven by the extension/retraction drive part to slide substantially horizontally toward the front from the housing position P2 to the protruding position P1. In this embodiment, the movement of the mounting frame part 222 between the housing position P2 and the protruding position P1 is performed automatically, but the configuration is not necessary to limit this, and the mounting frame part 222 can also be configured to be moved manually.

The apparatus base part 221 is a part located below the mounting frame part 222 when housed inside the housing 6, and is configured to temporarily receive medicine that fall from the receiving parts 21a of the receiving member 21 mounted to the mounting frame part 222, and to feed the received medicine to the packaging part 5 at a predetermined timing. Specifically, the apparatus base part 221 has a box shape opening upward, and includes a plurality of temporary receiving parts for temporarily receiving medicine therein. The temporary receiving parts are disposed below the respective receiving parts 21a at positions respectively corresponding to the respective receiving parts 21a.

As shown in FIG. 3 and FIG. 4, the positioning protrusion 227 is a protruding portion that protrudes upward from the housing bottom part 226, and is disposed at a position corresponding to the positioning recess 28 of the receiving member 21 (receiving member main body 25) to be attached. Specifically, the positioning recess 28 is disposed in the mounting recess 22a at a position offset to either the left or right in the left-right direction and to either the front or rear in the depth direction, and in this embodiment, is disposed at a position close to the rear of the right end. Such a positioning protrusion 227 can fit into the positioning recess 28 of the receiving member 21 when the receiving member 21 is properly attached to the mounting frame part 222.

The second connector 228 is a connector provided so as to protrude upward from the housing bottom part 226, and is provided so as to be connectable to the first connector 272 of the receiving member 21 attached to the mounting frame part 222. The second connector 228 is configured as a floating connector and movable in the horizontal direction. The horizontal movable range of the second connector 228 is a range that can absorb errors that occur in the horizontal position of the receiving member 21 relative to the mounting frame part 222 when the receiving member 21 is attached to the mounting frame part 222. Therefore, even if the position of the first connector 272 relative to the second connector 228 is misaligned due to an error or the like during mounting, the second connector 228 can be connected to the first connector 272. The second connector 228 is provided with a plurality of terminals corresponding to the terminals provided in the first connector 272, specifically, provided with a power feeding terminal for power feeding, a communication terminal for information communication, and a ground terminal for electrical grounding.

The first connector 272 and the second connector 228 are configured as plug and play connectors that allow plugging and playing. In this embodiment, the first connector 272 and the second connector 228 each have the ground terminal for electrical grounding, and are configured so that when the first connector 272 is inserted into the second connector 228, the ground terminals become conductive with each other before the other terminals become conductive with each other within the connectors, and when the first connector 272 is pulled out from the second connector 228, the ground terminals lose conductivity with each other after the other terminals lose conductivity.

As shown in FIG. 3, each grounding part 229 is made of a conductive material and is electrically grounded. The grounding part 229 is configured to have elasticity that allows itself to be compressed in the vertical direction, and in this embodiment is made of conductive fiber. In the state where the receiving member 21 is mounted to the mounting frame part 222, the grounding part 229 comes into contact with the bottom part 26 of the mounted receiving member 21 and is electrically connected to the bottom part 26. Specifically, the grounding part 229 is arranged at each of two positions: a position corresponding to below the first connection part 26a that contacts the first bottom plate part 26A located at the fixed position, and a position corresponding to below the second connection part 26b that contacts the second bottom plate part 26B located at the fixed position. Each of the grounding parts 229 contacts the first connection part 26a or the second connection part 26b, thereby enabling the bottom part 26 to be electrically grounded via the grounding parts 229. In this embodiment, in the state where the receiving member 21 is mounted to the mounting frame part 222, the first connection part 26a and the second connection part 26b are disposed at positions at which they can compress the grounding parts 229 in the vertical direction. Therefore, the elasticity (restoring force) of the grounding parts 229 can reliably ensure that the first connection part 26a and the second connection part 26b are electrically conductive with the grounding parts 229, thereby ensuring that the bottom part 26 is electrically grounded.

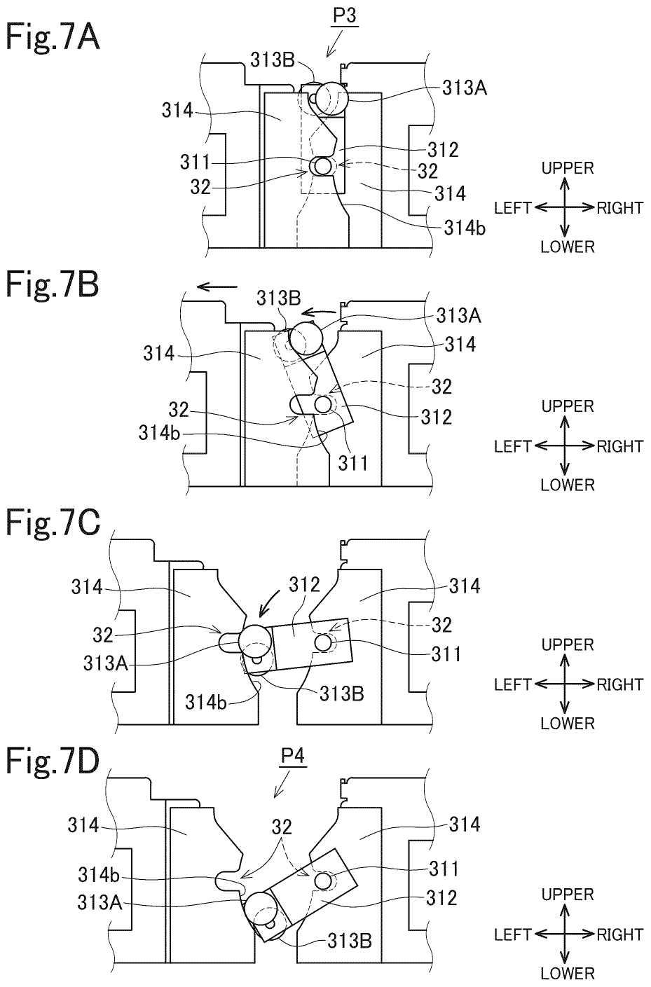

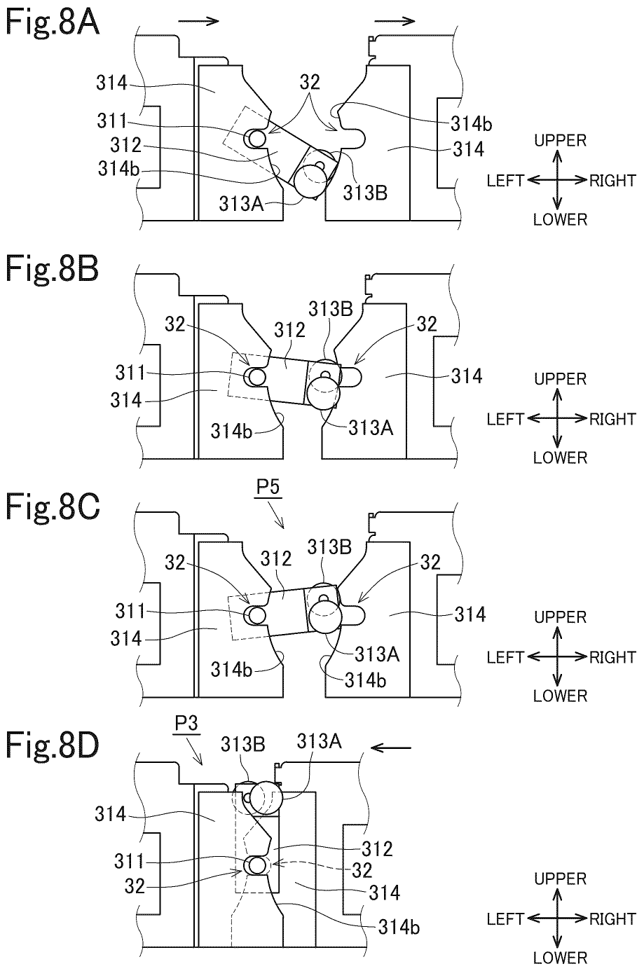

As shown in FIG. 6 and FIG. 7A to FIG. 7D, the opening/closing drive part 3 includes a drive main body 31 that drives to open and close the bottom part 26 of the receiving member 21 mounted to the mounting frame part 222, and a vibration part 32 that vibrates the bottom part 26 when the bottom part 26 opens. Specifically, according to the opening/closing drive part 3, the drive main body 31 engages with the first bottom plate part 26A and the second bottom plate part 26B, respectively, and moves the first bottom plate part 26A and the second bottom plate part 26B relative to each other in the left-right direction, thereby overlapping the opening portion 265 of the first bottom plate part 26A and the opening portion 265 of the second bottom plate part 26B in the vertical direction to open the bottom of the receiving part 21a. FIG. 6 is a view seen from the rear side, and FIG. 7A to FIG. 7D and FIG. 8A to FIG. 8D are views seen from the front side, so that the left and right of the figure are inverted in FIG. 6. That is, in FIG. 6, the illustrated left side is the actual right side, and the illustrated right side is the actual left side.

The drive main body 31 includes: a rotating part 312 that receives a driving force and rotates around a drive shaft 311 extending in the depth direction; a drive abutment part 313 that is disposed to protrude in the depth direction from the rotating part 312; a drive plate part 314 that can abut against the drive abutment part 313 and move in the left-right direction; and an opening/closing pressure part 315 that is connected to the drive plate part 314 and extends upward. In this embodiment, the drive main body 31 includes a pair of the drive plate parts 314 and a pair of the opening/closing pressure parts 315, and the pair of the drive plate parts 314 and the pair of the opening/closing pressure parts 315 are respectively arranged on the left and right sides with the drive shaft 311 therebetween (note that in this embodiment, the opening/closing pressure parts 315 are arranged at positions shifted from each other in the left-right direction relative to the drive shaft 311, that is, they are offset). The pair of the drive plate parts 314 and the pair of the opening/closing pressure parts 315 are connected by a spring 316, and are biased so that the pair of the drive plate parts 314 and the pair of the opening/closing pressure parts 315 approach each other in the left-right direction (so that they move toward the drive shaft 311). The pair of the drive plate parts 314 are restricted by a stopper (not shown) from moving further toward the drive shaft 311 than the position shown in FIG. 6. Further, the pair of the drive plate parts 314 are configured to be symmetrical with respect to the drive shaft 311 when viewed from the rear side (as shown in FIG. 6). In this embodiment, as indicated by the dashed line in FIG. 6, the drive plate part 314 is disposed on the rear side (front side) of the rotating part 312 so that it is hidden by other members.

The rotating part 312 is a plate shaped body that extends in a direction orthogonal to the drive shaft 311, and in this embodiment, has one end portion in the extension direction connected to the drive shaft 311. The rotating part 312 is connected to the drive shaft 311 so as to be able to rotate around the drive shaft 311 as the drive shaft 311 rotates.

The drive abutment part 313 is a part that protrudes in the depth direction from the rotating part 312, and in this embodiment, it is arranged to protrude to one side and the other side in the depth direction, in which the drive abutment part 313 (first drive abutment part 313A) protruding to one side (front side) abuts against the left-side drive plate part 314, and the drive abutment part 313 (second drive abutment part 313B) protruding to the other side (far side) abuts against the right-side drive plate part 314. The drive abutment part 313 is a cylindrical part having a circular cross section orthogonal to the drive shaft 311. Such a drive abutment part 313 is connected to the rotating part 312 via a bearing and is capable of rotating integrally with the rotating part 312 around the drive shaft 311, and is also connected to the rotating part 312 so as to be capable of rotating relatively to the rotating part 312 around an axis of the drive abutment part 313. In this embodiment, the drive shaft 311 rotates counterclockwise when viewed from the front, and the drive abutment part 313 rotates counterclockwise about the drive shaft 311 when viewed from the front.

The drive plate part 314 is a plate shaped body having an outer edge portion positioned on the driving shaft 311 side, along which the drive contact part 313 moves, and is configured to move left and right when pressed by the drive abutment part 313. In this embodiment, when pressed by the drive abutment part 313, the drive plate part 314 moves away from the drive shaft 311 in the left-right direction, and when it is not pressed by the drive abutment part 313, the spring 316 connecting the pair of the drive plate parts 314 maintains the state where the pair of the drive plate parts 314 are located close to each other in the left-right direction. Further, an open maintaining part 314b is provided on the outer edge portion (excluding the cutout for the vibration part 32) located on the drive shaft 311 side of the drive plate part 314 (see FIG. 7A to FIG. 7D and FIG. 8A to FIG. 8D). The open maintaining part 314b is an arc-shaped cutout part whose edge extends along the trajectory of the drive abutment part 313 rotating around the drive shaft 311, and is a part against which the drive abutment part 313 abuts at a stop position P4 or P5 described below.

The opening/closing pressure part 315 is a rod-shaped part that is connected to the drive plate part 314 and extends in the vertical direction, and moves in the left-right direction integrally with the drive plate part 314. The opening/closing pressure part 315 is disposed at a position at which it can engage with the opening/closing engaging part 262 of the bottom part 26. Specifically, the opening/closing pressure part 315 connected to the drive plate part 314 located on the left side is disposed at a position adjacent to the right side of the opening/closing engagement part 262 of the first bottom plate part 26A located on the left side, and the opening/closing pressure part 315 connected to the drive plate part 314 located on the right side is disposed at a position adjacent to the left side of the opening/closing engagement part 262 of the second bottom plate part 26B located on the right side.

The vibration part 32 is configured to apply vibration to the bottom part 26 by motion of the drive main body 31 to open the bottom part 26. Specifically, the vibration part 32 is disposed on the outer edge portion of the drive plate part 314 on the drive shaft 311 side, and is configured to engage with the drive abutment part 313 that moves along the outer edge portion so as to be able to apply vibration (impact) in the left-right direction to the drive plate part 314; in this embodiment, this is a cutout part formed in the outer edge portion (specifically, the open maintaining portion 314b). The size of the cutout part as the vibration part 32 is large enough to allow a part of the drive abutment part 313 to fit therein without impeding the rotation of the rotation part 312.

The motion of opening and closing the bottom part 26 of the opening/closing drive part 3 configured as above will be described with reference to FIG. 7A to FIG. 7D and FIG. 8A to FIG. 8D. FIG. 7A to FIG. 7D and FIG. 8A to FIG. 8D are shown as viewed from the front, unlike FIG. 6, and are therefore inverted from FIG. 6.

When the opening/closing drive part 3 opens or closes the bottom part 26, the drive shaft 311 is rotated, and the drive abutment part 313 is rotated around the drive shaft 311. As the drive abutment part 313 rotates around the drive shaft 311, the drive abutment part 313 abuts against the outer edge portion of the drive plate part 314 on the driving shaft 311 side. In this embodiment, the drive shaft 311 rotates counterclockwise when viewed from the front. As shown in FIG. 7A, the fixed position of the drive abutment part 313 is the upper end part (stop position P3) of the trajectory around the drive shaft 311. The drive abutment part 313 is located at the stop position P3 when the bottom part 26 is not opened.

As shown in FIG. 7B, when the drive shaft 311 rotates counterclockwise when viewed from the front, the first drive abutment part 313A and the second drive abutment part 313B first move downward and to the left. At this time, the first drive abutment part 313A abuts against the outer edge portion on the driving shaft 311 side of the left-side drive plate part 314, and presses the left-side drive plate part 314 to the left. The left-side drive plate part 314 is pressed in a direction away from the drive shaft 311 (leftward) by the first drive abutment part 313A and moves to the left. At this time, the second drive abutment part 313B does not abut against the right-side drive plate part 314, so that the right-side drive plate part 314 does not move.

When the drive shaft 311 further rotates counterclockwise when viewed from the front, the first drive abutment part 313A and the second drive abutment part 313B move downward. At this time, as shown in FIG. 7C, the first drive abutment part 313A moves along the outer edge portion (open maintaining portion 314b) on the driving shaft 311 side of the left-side drive plate part 314 and fits into the cutout serving as the vibration part 32 along the way. When the drive shaft 311 further rotates counterclockwise when viewed from the front, the first drive abutment part 313A comes out of the cutout serving as the vibration part 32, as shown in FIG. 7D. When the first drive abutment part 313A fits into the cutout and comes out of the cutout, an impact is applied to the left-side drive plate part 314, causing the left-side drive plate part 314 to vibrate due to the impact. In this embodiment, the left-side drive plate part 314 vibrates so as to move abruptly in the left-right direction due to the impact of the first drive abutment part 313A fitting into the cutout. At this time, the second drive abutment part 313B does not abut against the right-side drive plate part 314, so that the right-side drive plate part 314 does not move.

As shown in FIG. 7D, in this embodiment, at a position (stop position P4) where the first drive abutment part 313A passes over the cutout serving as the vibration part 32 and maintains the state in which the first drive abutment part 313A abuts against the outer edge portion on the driving shaft 311 side of the left-side drive plate part 314, the rotation of the driving shaft 311 temporarily stops, and the first drive abutment part 313A maintains the state where it is pressing the left-side drive plate part 314 to the left. In this embodiment, a sensor (e.g., a magnetic sensor that detects a magnet disposed in the first drive abutment part 313A or the rotating part 312) is provided to detect the first drive abutment part 313A which has reached the position at which it should stop, and the position of the first drive abutment part 313A is obtained by the sensor, and control is made for temporary stop. Then, after a predetermined time (the time required in relation to the motion of the bottom part 26) has elapsed since the drive shaft 311 stopped rotating, the drive shaft 311 starts rotating again, and the first drive abutment part 313A moves further along the left-side drive plate part 314.

As shown in FIG. 8A, when the drive shaft 311 rotates further counterclockwise when viewed from the front, the first drive abutment part 313A and the second drive abutment part 313B move downward and to the right, pass through the lower end of the trajectory around the drive shaft 311, and move further upward and to the right. At this time, the left-side drive plate part 314 is biased by the spring 316 to move together with the first drive abutment part 313A in a direction approaching the drive shaft 311 (to the right). At this time, the second drive abutment part 313B also abuts against the outer edge portion on the driving shaft 311 side of the right-side drive plate part 314, and presses the right-side drive plate part 314 to the right. The right-side drive plate part 314 is pressed in a direction away from the drive shaft 311 (to the right) by the second drive abutment part 313B and moves to the right. That is, in this embodiment, the left-side drive plate part 314 and the right-side drive plate part 314 are moved to the right side substantially simultaneously by the biasing force of the spring 316 and the pressure of the second drive abutment part 313B. The left-side drive plate 314 is moved to the right by the spring 316 until the movement is restricted by a stopper (not shown).

Thereafter, when the drive shaft 311 further rotates counterclockwise when viewed from the front, the first drive abutment part 313A and the second drive abutment part 313B move upward. At this time, as shown in FIG. 8B, the second drive abutment part 313B moves along the outer edge portion (open maintaining portion 314b) on the driving shaft 311 side of the right-side drive plate part 314 and fits into the cutout serving as the vibration part 32 along the way. When the drive shaft 311 further rotates counterclockwise when viewed from the front, the second drive abutment part 313B comes out of the cutout serving as the vibration part 32, as shown in FIG. 8C. When the second drive abutment part 313B fits into the cutout and comes out of the cutout, an impact is applied to the right-side drive plate part 314, causing the right-side drive plate part 314 to vibrate due to the impact. In this embodiment, the right-side drive plate part 314 vibrates so as to move abruptly in the left-right direction due to the impact of the second drive abutment part 313B fitting into the cutout. At this time, the first drive abutment part 313A does not abut against the left-side drive plate part 314, so that the left-side drive plate part 314 does not move.

As shown in FIG. 8C, in this embodiment, when the second drive abutment part 313B passes over the cutout serving as the vibration part 32 and maintains the state where the second drive abutment part 313B abuts against the outer edge portion on the driving shaft 311 side of the right-side drive plate part 314 (stop position P5), the rotation of the drive shaft 311 temporarily stops, and the second drive abutment part 313B maintains the state where it is pressing the right-side drive plate part 314 to the right. In this embodiment, a sensor (e.g., a magnetic sensor that detects a magnet disposed in the second drive abutment part 313B or the rotating part 312) is provided to detect the second drive abutment part 313B which has reached the position at which it should stop, and the position of the second drive abutment part 313B is obtained by the sensor, and control is made for a temporary stop. Then, after a predetermined time (the time required in relation to the motion of the bottom part 26) has elapsed since the drive shaft 311 stopped rotating, the drive shaft 311 starts rotating again, and the second drive abutment part 313B moves further along the left-side drive plate part 314.

Thereafter, when the drive shaft 311 further rotates counterclockwise when viewed from the front, the first drive abutment part 313A and the second drive abutment part 313B move upward and to the left, and return to their fixed positions (stop position P3) as shown in FIG. 8D. At this time, the right-side drive plate part 314 is biased by the spring 316 to move together with the second drive abutment part 313B in a direction approaching the driving shaft 311 (to the left). At this time, the first drive abutment part 313A does not abut against the left-side drive plate part 314, so that the left-side drive plate part 314 does not move.

As described above, by the rotation of the drive shaft 311, one (left-side) drive plate part 314 and the other (right-side) drive plate part 314 move in the left-right direction. Moreover, vibrations caused by the vibration part 32 are generated alternately in the left-side drive plate part 314 and the right-side drive plate part 314.

When the drive plate parts 314 move as described above, the opening/closing pressure parts 315 connected to the drive plate parts 314 move integrally with the drive plate parts 314. Specifically, the opening/closing pressure part 315 connected to one (left-side) drive plate part 314 moves to the left by the abutment of the first drive abutment part 313A against the drive plate part 314, and the first drive abutment part 313A fits into and comes out of the vibration part 32, causing vibration in the left-right direction, and then moves toward the drive shaft 311 (right side). The opening/closing pressure part 315 connected to the other (right-side) drive plate part 314 moves to the right by the abutment of the second drive abutment part 313B against the drive plate part 314, and the second drive abutment part 313B fits into and comes out of the vibration part 32, causing vibration in the left-right direction, and then moves toward the drive shaft 311 (left side).

As the opening/closing pressure parts 315 move in the left-right direction, the bottom parts 26 having the opening/closing engagement parts 262 that engage with the opening/closing pressure portions 315 move in the left-right direction, and as the opening/closing pressure parts 315 vibrate while engaging with the opening/closing engagement parts 262, the bottom parts 26 having the opening/closing engagement parts 262 vibrate.

Specifically, first, the opening/closing pressure part 315 connected to one (left-side) drive plate part 314 moves to the left. Then, the opening/closing engagement part 262 of the first bottom plate part 26A is pressed to the left, and the first bottom plate part 26A moves to the left from its fixed position. At this time, the second bottom plate part 26B does not move. Here, as the first bottom plate part 26A moves, the opening portions 265 provided in the first bottom plate part 26A respectively overlap with the corresponding opening portions 265 provided in the second bottom plate part 26B in the vertical direction, so that the bottoms of the receiving parts 21a (the receiving parts 21a in the odd-numbered row from the left) corresponding to the positions at which the opening portions 265 of the second bottom plate part 26B, which is in a fixed position, are located open, and the medicine falls downward from the receiving parts 21a.

Further, when the opening/closing pressure part 315 vibrates, the vibration is transmitted to the first bottom plate part 26A via the opening/closing engagement part 262, causing the first bottom plate part 26A to vibrate. In this way, when the first bottom plate part 26A vibrates with the bottoms of the receiving parts 21a open, for example, medicine that are held by the first bottom plate part 26A and prevented from falling from the receiving parts 21a can be released from the held state by the vibration and allowed to fall downward from the receiving parts 21a. The vibration of the bottom parts 26 are also transmitted to the receiving parts 21a, causing the receiving parts 21a themselves to vibrate, which release the medicine that have been held by the receiving parts 21a due to the static electricity of the medicine itself or the medicine (especially capsules) leaning against each other, allowing the medicine to fall downward from the receiving parts 21a.

Thereafter, the opening/closing pressure part 315 connected to one (left-side) drive plate part 314 moves to the right, and the opening/closing pressure part 315 connected to the other (right-side) drive plate part 314 moves to the right. When the left-side opening/closing pressure part 315 moves to the right, the spring 263 provided on the bottom part 26 causes the first bottom plate part 26A to move to the right and return to its fixed position. When the first bottom plate part 26A returns to its fixed position, it abuts against the first connection part 26a, which is electrically grounded via the grounding part 229, and is thus electrically grounded. When the right-side opening/closing pressure part 315 moves to the right, the opening/closing engagement part 262 of the second bottom plate part 26B is pressed to the right, and the second bottom plate part 26B moves to the right from its fixed position. At this time, the first bottom plate part 26A and the second bottom plate part 26B move to the right with their respective opening portions 265 remaining overlapped each other in the vertical direction, and the bottoms of the receiving parts 21a (the receiving pars 21a in the even-numbered row from the left) corresponding to the positions at which the opening portions 265 of the first bottom plate part 26A, which is in its fixed position, are located opens, and the medicine falls downward from the receiving parts 21a.

Further, when the opening/closing pressure part 315 vibrates, vibration is transmitted to the second bottom plate part 26B via the opening/closing engagement part 262, causing the second bottom plate part 26B to vibrate. In this way, when the second bottom plate part 26B vibrates with the bottoms of the receiving parts 21a remaining open, for example, medicine that is held by the second bottom plate part 26B and prevented from falling from the receiving parts 21a can be released from the held state by the vibration and allowed to fall downward from the receiving parts 21a. The vibration of the bottom parts 26 is also transmitted to the receiving parts 21a, causing the receiving parts 21a themselves to vibrate, which release the medicine that have been held by the receiving parts 21a due to the static electricity of the medicine itself or the medicine (especially capsules) leaning against each other, allowing the medicine to fall downward from the receiving parts 21a.

Thereafter, the other (right-side) drive plate part 314 moves to the left. Then, the spring 263 provided on the bottom part 26 moves the second bottom plate part 26B to the left. At this time, the first bottom plate part 26A does not move. When the second bottom plate part 26B returns to its fixed position, it abuts against the second connection part 26b, which is electrically grounded via the grounding part 229, and is thus electrically grounded.

The destaticizer 23 is a part capable of eliminating static electricity from medicine moving inside the medicine feeding apparatus 2, and in this embodiment, is configured to eliminate static electricity from medicine received in the receiving member 21 as it moves from the outside to the inside of the housing 6. The destaticizer 23 includes a discharge part 233, and is configured to generate ions by discharging from the discharge part 233, and neutralize medicine with the ions. As shown in FIG. 9A, FIG. 9B to FIG. 11, the destaticizer 23 includes a destaticizer main body 231 having the discharge part 233 that discharges and generates ions, and a static elimination control part 234 that controls the destaticizer 23 and applies a voltage to the destaticizer main body 231 (specifically, the discharge part 233). Such a destaticizer 23 is configured to receive power from a power supply part 9, which is supplied with an external power source, via the controller part 8, and the entire operation of the destaticizer 23 (specifically, turning the power of the destaticizer 23 on and off) is controlled by the controller part 8. In this embodiment, the power supply part 9 is a part that converts the power supplied from an external power source so that the power can be used by the medicine feeding apparatus 2, and specifically, is configured to transform the voltage of an AC external power source.

As shown in FIG. 9A, FIG. 9B, and FIG. 10A to FIG. 10C, the destaticizer main body 231 is provided inside the housing 6 and is configured to be able to eliminate static electricity from medicine received in the receiving parts 21a. In this embodiment, the destaticizer main body 231 is provided to eliminate static electricity from medicine received in the receiving member 21 (receiving parts 21a) rather than from the receiving member 21 itself. Moreover, the destaticizer main body 231 generates ions to eliminate static electricity from medicine received in the receiving parts 21a. That is, the destaticizer main body 231 is configured to be able to eliminate static electricity from medicine received in the receiving parts 21a in a non-contact manner. Specifically, the destaticizer main body 231 is a so-called ionizer that irradiates ions onto the surface of the medicine to eliminate static electricity from the surface of the medicine. Further, the destaticizer main body 231 of this embodiment is configured to discharge static electricity into the air, thereby imparting electric charges to molecules or the like in the air and ionizing the air. Specifically, the destaticizer main body 231 includes a rod-shaped base 232 and a plurality of discharge parts 233 arranged at intervals in the extension direction of the base 232. In this embodiment, the base 232 is disposed to have its extension direction coinciding with the long side direction of the receiving member 21 and to have its lower surface opposed to an upper surface of the receiving member 21. The discharge parts 30 are disposed below the base 232. The destaticizer main body 231 of this embodiment is configured as a windless ionizer that can feed generated ions to medicine without wind.

The base 232 is a rod-shaped body disposed inside the housing 5 to extend substantially parallel to the upper surface of the receiving member 11. The base 232 is a rod-shaped body extending in a linear direction substantially parallel to the long side direction of the receiving member 21. That is, the base 232 is disposed to allow the discharge parts 30 disposed on the base 232 to share the same distance to the upper surface of the receiving member 21. The base 232 of this embodiment is fixed inside the housing 6. Further, the base 232 of this embodiment is provided so as to be able to eliminate the static electricity from medicine received inside all of the receiving parts 21a when the receiving member 21 moves from the protruding position P1 to the housing position P2. Specifically, the base 232 is configured to be longer than the longitudinal (left-right) length of the area in which the receiving parts 21a of the receiving member 21 are provided, and is positioned so that when the receiving member 21 moves from the protruding position P1 to the housing position P2, ions can be fed to the medicine received inside all of the receiving parts 21a lined up in the short direction of the receiving member 21. In this embodiment, the destaticizer main body 231 (base 232) is fixedly positioned above the receiving parts 21a located at the frontmost side of the receiving member 21 located at the housing position P2. Therefore, it is possible to eliminate the static electricity from medicine received in all of the receiving parts 21a.

Each of the discharge parts 30 is a part capable of discharging the static electricity into the air by high voltage application. The discharge part 233 of this embodiment has a needle-shaped electrode therein, and discharges the static electricity from the electrode into the air by high voltage application to the electrode. Further, the discharge part 233 of this embodiment is configured so that the voltage applied to the electrode alternates between positive and negative at a predetermined period of time. In this embodiment, the period of time at which the voltage applied to the electrode by the discharge part 233 alternates between positive and negative is configured to be shorter than the time required for one receiving part 21a to pass under the destaticizer main body 231 when the receiving member 21 moves from the protruding position P1 to the housing position P2. That is, the discharge part 233 is configured to generate both positive and negative ions during one receiving part 21a passes under the destaticizer 23 when the receiving member 21 moves from the protruding position P1 to the housing position P2. The discharge part 233 of this embodiment applies a pulse voltage to the electrode. That is, the destaticizer main body 231 of this embodiment is configured as a pulse AC type ionizer. The destaticizer main body 231 of this embodiment is configured so that the pulse width of the pulse voltage applied to the electrode is controlled according to the charged state of a target object, and the amount of both positive and negative ions is adjusted (adjusting whether they are biased toward positive or negative).

As shown in FIG. 11, the static elimination control part 234 is a part that controls the destaticizer main body 231 and switches the destaticizer main body 231 (specifically, the discharge parts 233) between a state in which ions are generated and a state in which ions are not generated. The static elimination control part 234 of this embodiment performs ON/OFF control of the static elimination main body 231 by switching between a state in which power is supplied to the destaticizer main body 231 and a state in which power is not supplied thereto depending on the position of the receiving member 21. The static elimination control part 234 transforms (specifically, boosts) the power supplied from the power supply part 9 via the controller part 8 and supplies the power to the discharge part 233.

As shown in FIG. 9A, FIG. 9B and FIG. 11, the detection part 24 is a part that detects whether or not an external operator can touch the discharge part 233. Specifically, the detection part 24 is configured to detect whether a path is open that allows an operator working outside the housing 6 (e.g., placing medicine into the receiving parts 21a) to touch the discharge part 233, and if the path is open, it detects that there is a possibility that the operator's hand touches the discharge part 233. In this embodiment, when the apparatus main body 22 is pulled out from the housing 6 to the outside, the detection part 24 detects that the external operator can touch the discharge part 233, and when the apparatus main body 22 is housed in the housing 6, it determines that the external operator cannot touch the discharge part 233. The detection part 24 of this embodiment is a switch such as a limit switch that is configured to be pressed when the apparatus main body 22 is housed in the housing 6, and when the switch is pressed, it determines that the external operator cannot touch the discharge part 233, and when the switch is not pressed, it determines that the external operator can touch the discharge part 233. The detection part 24 transmits the detection result to the controller part 8, and specifically, when the switch is pressed, the detection part 24 transmits a signal to the controller part 8 indicating that the switch is pressed. The detection part 24 is not limited to being configured as a limit switch, and may be configured as a configuration other than a switch, such as an optical sensor.

As shown in FIG. 1, the input part 7 is a part to which information about the medicine to be packaged can be input. Specifically, information that can determine which medicine should be received in each receiving member 21a can be input to the input part 7. In this embodiment, prescription information is input to the input part 7. The prescription information includes information on which medicine should be packaged in each package. The input part 7 is formed of, for example, a touch panel. The touch panel can also be configured to allow information to be input through communication with an external terminal (such as a controller).

Further, information for operating the medicine feeding apparatus 2 can be input to the input part 7 of this embodiment. Specifically, as described below, after the medicine to be placed has been placed into the receiving parts 21a, information indicating that the medicine placing has been completed can be input to the input part 7.

As shown in FIG. 11, the controller part 8 controls the entire medicine packaging apparatus 1 including the medicine feeding apparatus 2. The controller part 8 controls the entire medicine apparatus 1 based on the information input to the input part 7. Specifically, the controller part 8 controls the automatic feeding apparatus 4 based on the prescription information input to the input part 7 to feed the medicine to be packaged to the packaging part 5. When the medicine to be packaged is not stored in the automatic feeding apparatus 4, it is determined that the medicine must be distributed manually, and the medicine feeding apparatus 2 is accordingly controlled. Specifically, the controller part 8 performs control so as to display the positions at which the medicine should be placed on the position indicator 27 attached to the mounting frame part 222 based on the information input to the input part 7. The control of the controller part 8 with respect to the position indicator 27 is transmitted to the position indicator 27 via a connector. The controller part 8 performs control to move the receiving member 21 out of and back into the housing 6 based on the information input to the input part 7. Specifically, when manual distribution of the medicine is required, the controller part 8 controls the receiving member 21 to move forward from the housing 6, and when an input is made to the input part 7 indicating that manual distribution of the medicine has been completed, the controller part 8 controls the receiving member 21 to be housed in the housing 6.

Further, the controller part 8 controls the power on and off of the destaticizer 23 based on the detection result of the detection part 24. Specifically, the controller part 8 controls the entire destaticizer 23 to be powered off when it is detected that an external operator can touch the discharge part 233, and it controls the entire destaticizer 23 to be powered on when it is detected that an external operator cannot touch the discharge part 233. In this embodiment, the controller part 8 turns on the power to the destaticizer 23 only when the switch of the detection part 24 is pressed (when a signal indicating that the switch has been pressed is received from the detection part 24), and turns off the power to the destaticizer 23 while no signal is being received. The controller part 8 of this embodiment controls ON/OFF of the power feeding to the destaticizer 23 by switching between a state in which power is fed to the destaticizer 23 and a state in which power is not fed to the destaticizer 23. In other words, when the detection part 24 detects that the external operator can touch the discharge part 233, only the power of the destaticizer 23 is turned off while the power of the medicine feeding apparatus 2 remains turned on.

Next, the operation of the medicine feeding apparatus 2 will be described.

When medicine needs to be manually distributed, the controller part moves the receiving member 21 to the projecting position P1. In this embodiment, the controller part 8 determines whether or not manual distribution is required based on the prescription information input to the input part 6, and when it determines that manual distribution is required, the controller part moves the receiving member 21 to the projecting position P1.

Next, the controller part 8 determines the receiving part 21a into which the manually dispensed medicine should be placed, based on the prescription information. Specifically, the controller part 8 determines that the receiving parts 21a corresponding to the packages in which the manually dispensed medicine is to be packaged are the receiving parts 21a into which the manually dispensed medicine should be placed.

When the receiving parts 21a into which the medicine should be placed manually are determined, the controller part 8 controls each of the position indicators 27 to control the light projecting part 271 to project light onto the inner wall surface of the receiving part 21a into which the medicine should be placed. Specifically, the controller part 8 controls the power feeding to the position indicator 27 and the projection of light onto the inner wall surface via a connector that connects the apparatus main body 22 and the receiving member 21. The position indicator 27 projects light onto the inner wall surface of the receiving part 21a into which the medicine is to be placed. Further, the light projecting part 271 of this embodiment projects colored light onto the inner wall surface of the receiving part 21a into which the medicine is to be placed. Then, the operator places the medicine into the receiving part 21a indicated by the position indicator 27.

When the operator places medicine into the receiving part 21a, the operator places the medicine wrapped in the PTP sheet directly into receiving part 21a, or temporarily transfers the medicine from the PTP sheet to another container and then places the medicine received in the container into the receiving part 21a. Here, the medicine placed into the receiving part 21a may be electrically charged due to, for example, friction with the PTP sheet, or friction with other medicine in the container.

When there are a plurality of types of medicine to be manually distributed, after placement of the first type of medicine is completed, information to select the second type of medicine is input into the input part 7. When the controller part 8 receives the information to select the second type of medicine, it controls the position indicator 27 to control the light projecting part 271 to project light onto the receiving part 21a into which the second type of medicine should be placed. Thereafter, the above control is repeated until all types of medicine to be manually distributed have been placed into the receiving parts 21a.

When all the medicine to be manually distributed have been placed, the operator checks whether the medicine received in the receiving parts 21a are appropriate. Here, when the operator checks the medicine placed into the receiving parts 21a, the light projecting part 271 projects white light onto the receiving part 21a into which one or more types of medicine should be placed. In this embodiment, when information to switch to white light is input into the input part 7, the controller part 8 controls the position indicator 27 to control the light projecting part 271 to project white light onto the receiving part 21a into which one or more types of medicine should be placed.

When the operator's checking is completed, the receiving member 11 moves from the projecting position P1 to the housing position P2. In this embodiment, when information indicating that the checking work has been completed is input to the input part 7, the controller part 8 controls the extension/retraction drive part to move the receiving member 21 from the protruding position P1 to the housing position P2. In this embodiment, the receiving member 21 moves relative to the destaticizer 23 so that the distance between the upper surface of the receiving member 21 and the destaticizer 23 (discharge part 233) is substantially kept constant.

The operator can detach the receiving member 21 from the mounting frame part 222 and place medicine to the receiving parts 21a at a location away from the mounting frame part 222. When the medicine is placed in this manner, the receiving member 21 is attached to the mounting frame part 222 after the placement of the medicine is completed, and the receiving member 21 moves from the protruding position PI to the housing position P2 after the attachment is completed. It can be configured such that, after the attachment is complete, the controller part 8 controls each of the position indicator 27 to allow the light projecting part 271 to project light onto the receiving part 21a into which one or more types of medicine should be placed.

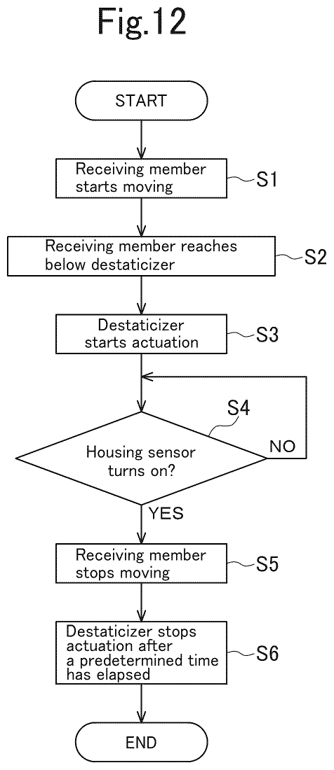

As shown in FIG. 10A to FIG. 10C and FIG. 12, the destaticizer 23 actuates when the receiving member 21 moves from the protruding position P1 to the housing position P2, and eliminates static electricity from the medicine received in the receiving member 21. In this embodiment, the destaticizer 23 starts and ends elimination of static electricity (generation of ions) based on the relative position between the receiving member 21 and the destaticizer 23.

As shown in FIG. 10A to FIG. 10C and FIG. 12, the receiving member 21 starts to move toward the far side from the protruding position P1 shown in FIG. 10A (static elimination step S1), and as shown in FIG. 10B, the end portion on the far side of the receiving member 21 moves to below the destaticizer 23 (static elimination step S2). When the receiving member 21 reaches below the destaticizer 23 (specifically, the discharge parts 233 of the destaticizer main body 231), the destaticizer 23 starts actuating (static elimination step S3), and specifically, the static elimination control part 234 applies a voltage to the discharge parts 233. In this embodiment, when a predetermined time (e.g., about 0.5 seconds) has elapsed since the receiving member 21 started to move, the controller part 8 determines that the receiving member 21 is located below the destaticizer 23 (discharge parts 233), and causes the static elimination control part 234 to start static elimination (application of voltage to the discharge parts 233). The time from when the receiving member 21 starts to move until the destaticizer 23 starts to eliminate static electricity is appropriately determined depending on the moving speed of the receiving member 21 and other factors. Further, the position of the receiving member 21 relative to the destaticizer 23 when the destaticizer 23 starts elimination of static electricity may be between the farthest part of the receiving member 21 and the receiving parts 21a arranged at the farthest side. By starting the elimination of static electricity before the arrival of the receiving member 21 in this positional relationship, it is possible to reliably eliminate static electricity from the medicine received in the receiving parts 21a while preventing ions from hitting conductors such as electrically grounded metal parts within the medicine feeding apparatus 2, which would disrupt the ion balance and cause the medicine to become reversely charged. In this embodiment, the destaticizer 23 continues to generate ions until the timing at which static elimination is to be ended, which will be described later.

The receiving member 21 continues to move toward the far side even after the end portion on the far side is positioned below the destaticizer 23, and stops moving when it reaches the housing position P2 as shown in FIG. 10C. Specifically, the receiving member 21 moves toward the far side until the housing sensor 224 detects that the mounting frame part 222 (and the receiving member 21 mounted to the mounting frame part 222) has been housed within the housing 6 (discharging step S4), and then stops (discharging step S5). In this embodiment, while the housing body 21 is located in the housing position P2, the receiving parts 21a arranged on the frontmost side of the housing body 21 are located below the destaticizer 23 (discharge parts 233).

The destaticizer 23 stops static elimination in a predetermined time after the receiving member 21 reaches the housing position P2 and stops moving (static elimination step S6). Specifically, when the housing sensor 224 detects that the mounting frame part 222 and the receiving member 21 mounted on the mounting frame part 222 have arrived at the housing position P2, it sends a signal to the controller part 8 to indicate that they have arrived at the housing position P2. The controller part 8 that has received the signal measures the time from the arrival of the signal, and when a predetermined time has elapsed, causes the static elimination control part 234 to stop static elimination (application of voltage to the discharge part 233).

Through the above steps, the movement of the receiving member 21 from the protruding position P1 to the housing position P2, and the static elimination of the medicine received in the receiving member 21 are completed. When the receiving member 21 moves to the housing position P2, the opening/closing drive part 3 engages with the bottom part 26 (opening/closing engagement part 262), and the opening/closing drive part 3 is driven to open and close the bottom part 26, thereby feeding the medicine received in the receiving parts 21a of the receiving member 21 to the target device (packaging part 5) via the apparatus main body 22.

According to the above described configuration, the receiving member 21 is provided with the position indicator 27 and is configured to be detachable from the apparatus main body 22, so that manual distribution of medicine can be performed even at a location away from the apparatus main body 22, and the efficiency of the manual distribution can be improved by the position indicator 27, at least when the receiving member 21 is attached to the apparatus main body 22. This improves the case of use of the medicine feeding apparatus 2.

Further, since the receiving member 21 and the apparatus main body 22 are electrically connected to each other by a hot-plug connector, the receiving member 21 can be attached to and detached from the apparatus main body 22 while the power to the apparatus main body 22 is still turned on. This improves the case of use of the medicine feeding apparatus 2.

Further, the receiving member 21 includes a first connector 272, and the apparatus main body 22 includes a second connector 228 to which the first connector 272 can be electrically connected, and at least one of the first connector 272 and the second connector 228 is a floating connector. Therefore, even if there is an error in the relative position between the receiving member 21 and the apparatus main body 22 when the receiving member 21 is attached to the apparatus main body 22, the receiving member 21 and the apparatus main body 22 can be electrically connected while absorbing the error, thereby improving the case of use of the medicine feeding apparatus 2.

The apparatus main body 22 has the positioning protrusion 227 that is disposed to protrude upward, the receiving member 21 has the positioning recess 28 into which the positioning protrusion 227 can fit, the first connector 272 is disposed to protrude downward from the receiving member 21, and the second connector 228 is disposed to protrude upward from the mounting frame part 222. Thus, the positioning protrusion 227 and the positioning recess 28 can guide the receiving member 21 to be attached to the appropriate position in the apparatus main body 22, and can guide the receiving member 21 to be attached in the vertical direction from above the apparatus main body 22, thereby promoting the first connector 272 to be properly fitted into the second connector 228. Further, since the positioning protrusion 227 and the positioning recess 28 are positioned at offset positions in the left-right and depth directions, it is possible to prevent the receiving member 21 from being attached to the apparatus main body 22 with its position reversed in the depth direction or left-right direction.

Further, since the positioning recess 28 is a hole that penetrates the receiving member 21 in the vertical direction, the operator who attaches the receiving member 21 to the apparatus main body 22 can recognize the position of the positioning recess 28 relative to the positioning protrusion 227 through the hole. Therefore, it is possible to easily check whether the receiving member 21 is properly attached to the apparatus main body 22 or not.

There is provided the bottom part 26 that defines the bottom of the receiving parts 21a, and the bottom part 26 is conductive and is electrically grounded via the apparatus main body 22 in a state in which the receiving member 21 is attached to the apparatus main body 22. Therefore, since the bottom part 26 is electrically grounded via the apparatus main body 22, the electric charge that accumulates in the bottom part 26 can be released via the apparatus main body 22. This prevents electronic components or the like included in the position indicator 27 from malfunctioning or breaking down due to discharge from the bottom part 26, and also prevents the medicine placed into the receiving part 21a from becoming charged with electricity due to the electric charge accumulated in the bottom part 26.

Further, the apparatus main body 22 has a grounding part 229 with which the bottom part 26 can come into contact, the grounding part 229 is an electrically grounded conductor and has elasticity that allows itself to be compressed in the vertical direction, and in the state where the receiving member 21 is attached to the apparatus main body 22, the bottom part 26 is configured to compress the grounding part 229 in the vertical direction. Therefore, the elasticity of the grounding part 229 ensures that the bottom part 26 is electrically conductive to the grounding part 229, so that the bottom part 26 can be reliably electrically grounded.

Further, since the receiving member 21 includes the vibration part 32 that vibrates the receiving member 21, the medicine or the like that is held on the receiving member 21a can be allowed to fall by the vibration of the vibration part 32, so that the medicine received in the receiving parts 21a can be reliably fed to the target device.

Further, the receiving member 21 includes the bottom part 26 that defines the bottoms of the receiving parts 21a, the bottom part 26 is openable and closable, and the vibration part 32 vibrates the bottom part 26 when the bottom part 26 opens, so that the medicine held on the bottom part 26 can be reliably allowed to fall by the vibration. Therefore, the medicine received in the receiving parts 21a can be reliably fed to the target device.

The apparatus main body 22 includes the opening/closing drive part 3, which is includes the drive main body 31 that drives the bottom part 26 to open and close, the vibration part 32 provided in the drive main body, and the vibration part 32 applies vibrations to the bottom part 26 by the action of the drive main body 31 to open the bottom part 26. Therefore, since the bottom part 26 is vibrated by the motion of the driving main body 31 to open the bottom part 26, vibrations can be reliably applied when the bottom part 26 opens, so that the medicine received in the receiving parts 21a can be reliably fed to the target device.

Further, since the vibration part 32 is provided in the apparatus main body 22, the size of the receiving member 21 can be prevented from increasing, making the receiving member 21 easy to carry, while ensuring the feeding of the medicine received in the receiving parts 21a. Further, since the opening/closing drive part 3 itself has a mechanism for generating vibrations (vibration part 32), the entire apparatus can be made more compact than the configuration with a separate vibrator provided.

The position indicator 27 includes the light projecting part 271, which is configured to project light onto the inner wall surface of the receiving 21a (the inner surface of the side wall 211) to illuminate the inner wall surface of the receiving part 21a. According to this configuration, the receiving part 21a itself (the recess itself) is illuminated by the light, and therefore it is easier to recognize the position at which the medicine should be placed compared to, for example, the configuration that a peripheral area of the receiving part 21a is illuminated.

Further, since the static electricity of the medicine can be eliminated by the destaticizer 23, it is possible to prevent malfunctions in the device to which the medicine is fed due to the medicine becoming charged, and since the controller part 8 turns off the power to the destaticizer 23 in response to detection by the detection part 24, it is possible to prevent the operator from touch the discharge part 233 in operating state.

The device also includes the receiving member 21 having the plurality of receiving parts 21a capable of receiving medicine, the receiving parts 21a being open upward so that medicine can be placed into the receiving parts 21a from above, and the destaticizer 23 which eliminates static electricity from the medicines received in the receiving parts 21a. Therefore, the static electricity of the medicine received in the receiving parts 21a can be eliminated, so that malfunctions in the device to which the medicine is to be fed due to the medicine charged with electricity can be suppressed.

Further, when the detection part 24 detects that the external operator is able to touch the destaticizer 23, the controller part 8 turns off only the power of the destaticizer 23. Therefore, the time required for recovery can be shortened compared to the configuration that the power to the entire apparatus is turned off.

Also included are the discharge part 233 that discharges, and the static elimination control part 234 that applies a voltage to the discharge part 23. The controller part 8 is configured not to feed the power to the static elimination control part 234 when the power to the destaticizer 23 is turned off. Therefore, when the operator is able to touch the discharge part 233, no power is fed to the static elimination control part 234, so that it is possible to prevent voltage from being applied to the discharge part 233 due to malfunction or the like of the static elimination control part 234, and it is possible to reliably prevent the operator from touching the discharge part 233 in operating state.

The detection part 24 is capable of detecting that the external operator is unable to touch the static elimination part 23, and the controller part 8 is configured to turn on the power of the static elimination part 23 when the detection part 24 detects that the external operator is unable to touch the static elimination part 23 after the power of the destaticizer 23 is turned off. Therefore, the controller part 8 turns on the power of the destaticizer 23 in response to the detection by the detection part 24, thereby preventing the operator from touching the discharge part 233 in operating state, while still being able to reliably turn on the power of the destaticizer 23 when the external operator is unable to touch the destaticizer 23. Thus, it is possible to ensure that the static electricity of the medicine can be eliminated by the destaticizer 23.

The destaticizer 23 starts to generate ions when the receiving member 21 reaches below the destaticizer 23. Therefore, by generating ions before the receiving member 21 reaches below the destaticizer 23, it is possible to suppress the destaticizer 23 from charging the medicine with generated ions as a result of the disruption of the ion balance. Since the static electricity of the medicine can be thus eliminated reliably, malfunctions in the device to which the medicine is fed can be suppressed.

Further, the destaticizer 23 starts elimination of static electricity before the receiving parts 21a, which are located at the farthest side of the receiving member 21, reach below the destaticizer 23, so that the static electricity of the medicine received in the receiving part 21a can be eliminated reliably.

Further, since the destaticizer 23 continues to eliminate static electricity for a predetermined period of time even after the receiving member 21 reaches the housing position P2, it is possible to reliably eliminate static electricity from the medicine located directly below the destaticizer 23 at the housing position P2. This can suppress a failure from occurring in the device to which the medicine is to be fed.

Hereinbefore, one embodiment of the present invention has been described by way of an example. However, the present invention is not limited to this embodiment, and various modifications can be made without departing from the gist of the present invention.

For example, as an example of the medicine feeding apparatus 2, the medicine feeding apparatus 2 provided in the medicine packaging apparatus 1 has been described, but the configuration is not limited to this, and the medicine feeding apparatus 2 can also be configured as an independent medicine feeding apparatus 2, or as an apparatus incorporated into an apparatus other than the medicine packaging apparatus 1.

Further, the medicine feeding apparatus 2 has been described as being configured such that the receiving member 21 is attachable to and detachable from the apparatus main body 22 and includes the destaticizer 23, but the configuration is not limited to this, and the medicine feeding apparatus 2 can also be configured such that it includes only either the receiving member 21 or the destaticizer 23, which are attachable to and detachable from the apparatus main body 22. Further, in the configuration in which the receiving member 21 is attachable to and detachable from the apparatus main body 22, a configuration in which the receiving member 21 does not include the position indicator 27 may be adopted. In the case where the receiving member 21 is configured not to include the position indicator 27, for example, the first connector 272 and the second connector 228 can feed the power to a vibration part or the like provided in the receiving member 21.

Further, while the position indicator 27 has been described as being configured to project light onto the inner wall surface of the receiving part 21a, the present invention is not limited to this configuration and various configurations capable of displaying the position at which the medicine should be placed can be adopted. For example, it may be configured as a light emitter provided on the upper end surface surrounding the receiving part 21a.

Further, the case has been described in which the receiving member 21 is electrically connected to the apparatus main body 22 via a connector and configured to receive the power and information for displaying by the position indicator 27 from the connector, but the configuration is not necessarily limited to this. For example, the position indicator 27 may be configured to receive the power from the apparatus main body 22 by non-contact power feeding, or may be configured to receive the power from a battery provided in the receiving member 21. Further, when such a configuration is adopted, the position indicator 27 can also be configured to receive information for displaying by wireless communication. Further, even when a connection using a connector is adopted, it is not limited to the case that the connector is configured to be hot-pluggable, but it is also possible to adopt a connector that is not hot-pluggable, and it is also possible to adopt a configuration that both the first connector 272 and the second connector 228 are not floating connectors.

Further, although the case has been described in which the bottom part 26 is driven by the opening/closing drive part 3 provided in the apparatus main body 22 to open and close the bottoms of the receiving parts 21a, the configuration is not limited to this, and the opening/closing drive part 3 can also be provided in the receiving member 21. Further, even when the opening/closing drive part 3 is provided, the opening/closing drive part 3 can have various configurations capable of opening and closing the bottom part 26.

Further, the vibration part 32 has been described as being provided in the opening/closing drive part 3, but is not limited to this configuration, and can be provided in a position other than the opening/closing drive part 3 of the apparatus main body 22 or can be provided in the receiving member 21. When such a configuration is adopted, a vibration device using an eccentric motor or an electromagnet can also be used as the vibration part.

Further, the vibration part 32 has been described as vibrating the bottom part 26, but is not limited to this configuration, and can be configured to vibrate the entire receiving member 21. When the entire receiving member 21 is vibrated, not only the medicine held on the bottom part 26 but also the medicine held on the inner wall surface or the like of the receiving part 21a can be released from such a held state and reliably fed.

In addition, the positioning of the receiving member 21 relative to the mounting frame part 222 has been described as being achieved by fitting the positioning protrusion 227 into the positioning recess 28, but the configuration is not limited to this, and the mounting frame part 222 can also be configured to include a pushing part that pushes the receiving member 21 to be attached toward one side in the horizontal direction. According to this configuration, the position of the receiving member 21 relative to the mounting frame part 222 can be appropriately adjusted by the pressure from the pushing part. A specific configuration of the pushing part can be, for example, a configuration in which a ball plunger or the like is disposed to be extendable outward and retractable inward from the mounting frame part 222 and has a plurality of protrusions that are biased to protrude (specifically, a configuration in which the protrusions are provided at parts A shown by the dashed line in FIG. 3), but the configuration is not limited to this. Further, in the case where the pushing part is adopted, the first connector 272 and the second connector 228 can be provided so as to be coupled with each other by the horizontal movement of the receiving member 21 caused by the pushing part. The configuration of the pushing part can also be such that it is attracted by an electromagnet, pressed by tilting, or biased in one direction by a bell.

Further, the destaticizer 23 has been described as eliminating static electricity from medicine received in the receiving member 21 that moves horizontally from the outside to the inside, but is not limited to this configuration, and can also be configured, for example, to eliminate static electricity from medicine that moves according to gravity along the medicine feeding path. Further, the destaticizer 23 has been described as eliminating static electricity from medicine that has been manually dispensed, but the configuration is not limited to this, and for example, it can be configured to eliminate static electricity from medicine that is fed from a cassette.

Further, the controller part 8 has been described as turning off the power only to the destaticizer 23 when the detection part 24 detects that the external operator is able to touch the discharge part 233, but the configuration is not limited to this and it can also be configured to turn off the power to the entire medicine feeding apparatus 2.

Further, the controller part 8 has been described as turning on the power when the detection part 24 detects that the external operator cannot touch the discharge part 233, but the configuration is not limited to this, and the power can also be turned on manually by the operator. When such a configuration is adopted, it is also possible to configure the apparatus such that, when the detection part 24 detects that the external operator cannot touch the discharge part 233, the apparatus prompts the operator to manually turn on the power.

The controller part 8 has been described as determining that the receiving member 21 is located below the destaticizer 23 when a predetermined time has elapsed since the receiving member 21 at the protruding position PI has started to move toward the far side. However, the configuration is not limited to this, and the configuration can be such that elimination of static electricity is started by, for example, detecting that the receiving member 21 is located below the destaticizer 23 using a sensor or the like, or by judging the position based on the drive amount of the extension/retraction drive part.

Further, although the controller part 8 has been described as determining that the receiving member 21 has arrived at the housing position P2 based on the detection of the housing sensor 224, the configuration is not limited to this, and it can also be configured, for example, to determine that the receiving member 21 has arrived at the housing position P2 based on the movement time of the receiving member 21 or the drive amount of the extension/retraction drive part.

Further, although the case has been described in which the receiving member 21 moves to have a vertical distance relative to the destaticizer 23 (discharge part 233) being substantially constant, the configuration is not limited to this, and the receiving member 21 can also move to have a vertical distance being not constant.

This embodiment will be summarized as follows.
(1) A medicine feeding apparatus of the present invention is a medicine feeding apparatus including a receiving member including a plurality of receiving parts in which medicine can be received, and an apparatus main body that feeds the medicine received in the plurality of receiving parts to a target device, in which the plurality of receiving parts are open upward and configured to allow an operator to manually place the medicine from above thereinto; the receiving member includes a plurality of position indicators that indicate which of the plurality of receiving parts the medicine should be placed thereinto; and the receiving member is configured to be attachable to and detachable from the apparatus main body.

According to the above described configuration, the receiving member is provided with the position indicator and is configured to be detachable from the apparatus main body, so that manual distribution of medicine can be performed even at a location away from the apparatus main body, and the efficiency of the manual distribution can be improved by the position indicator, at least when the receiving member is attached to the apparatus main body. This improves the ease of use of the medicine feeding apparatus.
(2) The medicine feeding apparatus according to (1), in which the receiving member and the apparatus main body are electrically connected to each other by a hot-plug connector.

According to this configuration, the receiving member can be attached to and detached from the apparatus main body while the power to the apparatus main body is still turned on. This improves the case of use of the medicine feeding apparatus.
(3) The medicine feeding apparatus according to (1) or (2), in which the receiving member includes a first connector; the apparatus main body includes a second connector electrically connectable to the first connector; and at least one of the first connector and the second connector is a floating connector.

According to this configuration, even if there is an error in the relative position between the receiving member and the apparatus main body when the receiving member is attached to the apparatus main body, the receiving member and the apparatus main body can be electrically connected while absorbing the error, thereby improving the case of use of the medicine feeding apparatus.
(4) The medicine feeding apparatus according to any one of (1) to (3), in which the receiving member includes a bottom part that defines bottoms of the plurality of receiving parts; and the bottom part is conductive and is electrically grounded via the apparatus main body in a state in which the receiving member is attached to the apparatus main body.

According to this configuration, since the bottom part is electrically grounded via the apparatus main body, the electric charge that accumulates in the bottom part can be released via the apparatus main body. This prevents electronic components or the like included in the position indicator from malfunctioning or breaking down due to discharge from the bottom part, and also prevents the medicine placed into the receiving part from becoming charged with electricity due to the electric charge accumulated in the bottom part.
(5) The medicine feeding apparatus according to any one of (1) to (4), in which the apparatus main body includes a mounting frame part to which the receiving member is attached; and the mounting frame part includes a pushing part that pushes the receiving member to be attached toward one side of the mounting frame part.

According to this configuration, since the mounting frame part includes the pushing part, the relative position between the receiving member and the mounting frame part can be stabilized.
(6) The medicine feeding apparatus according to any one of (1) to (5), further including a vibration part that vibrates the receiving member.

According to this configuration, the medicine or the like that is held on the receiving member can be allowed to fall by the vibration of the vibration part, so that the medicine received in the receiving parts can be reliably fed to the target device.
(7) The medicine feeding apparatus according to (6), in which the receiving member includes a bottom part that defines bottoms of the plurality of receiving parts; the bottom part is openable and closable; and the vibration part is configured to vibrate the bottom part when the bottom part opens.

According to this configuration, the bottom part is vibrated when the bottom part opens, so that the medicine held on the bottom part can be reliably allowed to fall by the vibration. Therefore, the medicine received in the receiving parts can be reliably fed to the target device.
(8) The medicine feeding apparatus according to (7), in which the apparatus main body includes an opening/closing drive part; the opening/closing drive part includes a drive main body that drives to open and close the bottom part of the receiving member, and the vibration part that is disposed in the drive main body; and the vibration part is configured to apply vibration to the bottom part by motion of the drive main body to open the bottom part.

According to this configuration, since the bottom part is vibrated by the motion of the driving main body to open the bottom part, vibrations can be reliably applied when the bottom part opens, so that the medicine received in the receiving parts can be reliably fed to the target device.

### REFERENCE SIGNS LIST

1: Medicine packaging apparatus
2: Medicine feeding apparatus
21: Receiving member
211: Side wall
22: Apparatus main body
22a: Mounting recess
221: Apparatus base part
222: Mounting frame part
224: Housing sensor
225: Frame part
226: Housing bottom part
227: Positioning protrusion
228: Second connector
229: Grounding part
23: Destaticizer
231: Destaticizer main body
232: Base
233: Discharge part
234: Static elimination control part
24: Detection part
25: Receiving member main body
251: Finger hook
252: Unevenness
253: Identification mark
26: Bottom part
26A: First bottom plate part
26b: First connection part
26B: Second bottom plate part
26b: Second connection part
261: Bottom plate main body
262: Opening/closing engagement part
263: Spring
264: Closing portion
265: Opening portion
27: Position indicator
271: Light projecting part
272: First connector
273: Light transmission part
28: Positioning recess
3: Opening/closing drive part
31: Drive main body
311: Drive shaft
312: Rotating part
313: Drive abutment part
313A: First drive abutment part
313B: Second drive abutment part
314: Drive plate part
314b: Open maintaining portion
315: Opening/closing pressure part
316: Spring
4: Automatic feeding apparatus
5: Packaging part
6: Housing
7: Input part
8: Controller part
9: Power supply part
S: Receiving area
P1: Protruding position
P2: Housing position

1. A medicine feeding apparatus comprising a receiving member including a plurality of receiving parts in which medicine can be received, and an apparatus main body that feeds the medicine received in the plurality of receiving parts to a target device, wherein
the plurality of receiving parts are open upward and configured to allow an operator to manually place the medicine from above thereinto;
the receiving member includes a plurality of position indicators that indicate which of the plurality of receiving parts the medicine should be placed thereinto; and
the receiving member is configured to be attachable to and detachable from the apparatus main body.

2. The medicine feeding apparatus according to claim 1, wherein the receiving member and the apparatus main body are electrically connected to each other by a hot-plug connector.

3. The medicine feeding apparatus according to claim 1 or 2, wherein
the receiving member includes a first connector;
the apparatus main body includes a second connector electrically connectable to the first connector; and
at least one of the first connector and the second connector is a floating connector.

4. The medicine feeding apparatus according to claim 1, wherein
the receiving member includes a bottom part that defines bottoms of the plurality of receiving parts; and
the bottom part is conductive and is electrically grounded via the apparatus main body in a state in which the receiving member is attached to the apparatus main body.

5. The medicine feeding apparatus according to claim 1, wherein
the apparatus main body includes a mounting frame part to which the receiving member is attached; and
the mounting frame part includes a pushing part that pushes the receiving member to be attached toward one side of the mounting frame part.

6. The medicine feeding apparatus according to claim 1, further comprising a vibration part that vibrates the receiving member.

7. The medicine feeding apparatus according to claim 6, wherein
the receiving member includes a bottom part that defines bottoms of the plurality of receiving parts;
the bottom part is openable and closable; and
the vibration part is configured to vibrate the bottom part when the bottom part opens.

8. The medicine feeding apparatus according to claim 7, wherein
the apparatus main body includes an opening/closing drive part;
the opening/closing drive part includes a drive main body that drives to open and close the bottom part of the receiving member, and the vibration part that is disposed in the drive main body; and
the vibration part is configured to apply vibration to the bottom part by motion of the drive main body to open the bottom part.
